(19) United States
(12) Patent Application Publication
(10) Pub. No.: US 2007/0015869 A1
(43) Pub. Date: Jan. 18, 2007

(54) Wear resistant high molecular weight polyacetal-ultrahigh molecular weight polyethylene compositions and articles formed therefrom

(76) Inventors: Ramabhadra Ratnagiri, Wilmington, DE (US); Edmund Arthur Flexman, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/449,429

(22) Filed: Jun. 8, 2006

Related U.S. Application Data
(60) Provisional application No. 60/688,495, filed on Jun. 8, 2005.

(51) Int. Cl. C08L 23/00; C08L 59/00; B32B 27/00

(52) U.S. Cl. 525/55; 522/161

(57) ABSTRACT

Composition comprising high molecular weight polyacetal and ultrahigh molecular weight polyethylene having improved wear resistance, high melt viscosity, and good mechanical properties. Articles comprising the compositions are disclosed.

This application claims the benefit of U.S. Provisional Application No. 60/688,495, filed Jun. 8, 2005.

### FIELD OF THE INVENTION

The present invention relates to compositions having good wear resistance comprising melt-mixed blends of ultrahigh molecular weight polyethylene and high molecular weight polyacetal. Articles formed therefrom are disclosed.

### BACKGROUND OF THE INVENTION

Many applications require that parts made from polymeric materials be in motion with respect to other parts they are in physical contact with. In such cases, it is desired that the polymeric materials have good wear resistance to avoid erosion of the surface of the parts at the point of contact. An example of such an application is a conveyor belt system where there is continuous contact between the conveyor elements and the structure supporting the elements while the conveyor is operating.

Ultrahigh molecular weight polyethylene (UHMWPE) is often used in applications requiring good wear resistance. UHMWPE has excellent resistance to abrasive wear, very high impact toughness, a low coefficient of friction, and good chemical resistance. The excellent wear resistance of UHMWPE is believed to result from a film transfer mechanism that transfers material onto the counter surface, resulting in the formation of a coherent film on the counter surface that inhibits wear. However, its flexural modulus is not always high enough for certain applications and it is restricted to applications requiring low temperatures (its useful upper temperature is believed to be about 75° C.) and low speed contact. Additionally, in wear applications involving the presence of hard abrasive particles, the particles can have a tendency to imbed in the soft UHMWPE, leading to increased wear. Furthermore, it lacks significant melt extensibility, meaning that it can't be drawn in the melt and thus that shaping processes to form articles from UHMWPE are typically limited to non-melt processes such as ram extrusion and compression molding and UHMWPE is not generally suitable for use with conventional melt-processing techniques (e.g. injection molding, melt extrusion, etc.), which limits the variety of articles that can be conveniently made.

Polyacetals (also known as polyoxymethylenes or POM) are known to have excellent tribology and good physical properties and have low friction when in contact with steel surfaces. Polyacetals can be used at temperatures above 90° C. and are generally melt-processable. However, the film transfer mechanism that is believed to contribute to the wear resistance of UHMWPE is not believed to play a significant role in the wear resistance of polyacetals and the wear surfaces of polyacetals tend to become gouged with extended use.

Articles for use in many wear applications are formed by extrusion processes that require the use of a material having a high melt viscosity, but a sufficient degree of melt extensibility to allow for melt processing. It would be desirable to obtain a melt-processable polymeric composition having improved wear resistance properties and high melt viscosity in conjunction with good mechanical properties and that is suitable for use at elevated temperatures.

The following disclosures may be relevant to various aspects of the present invention and may be briefly summarized as follows:

Japanese published patent application 2001-059042 A discloses a polyolefin resin composition composed of ultrahigh molecular weight polyethylene and low or high molecular weight polyolefin and heat resistant resin. Japanese published patent application H04-351647 A discloses resins having improved sliding properties comprising ultrahigh molecular weight polyethylene having an intrinsic viscosity of 6 dl/g or higher and polyethylene having an intrinsic viscosity of 0.1-5 dl/g, where the polyethylenes are modified with at least one modifying monomer and a polymer such as polyamide, polyacetal, polyester, and polycarbonate. Japanese published patent application H01-126359 A discloses a polyacetal resin composition having good abrasion and friction properties optionally containing superhigh molecular weight polyethylene.

Japanese published patent application H01-104622 A discloses a product obtained by dipping a product obtained from a synthetic resin containing ultra macromolecular polyethylene in a lubricating oil. Japanese patent H07-051657 B2 discloses a polyacetal composition having good sliding properties containing 95 to 80 weight percent polyacetal and 5 to 20 weight percent ultrahigh molecular weight polyethylene. Japanese patent H06-062831 B2 discloses a method of dispersing 1 to 15 weight percent of fine powder ultrahigh molecular weight polyethylene in polyacetal resin. U.S. Pat. No. 4,670,508 discloses a thermoplastic resin composition comprising a melt-mixed blend of 70 to 98 weight percent of a thermoplastic resin chosen from polyamides, polyacetals, polyesters, and polycarbonates and 30 to 2 weight percent of an ultra high molecular weight polyolefin powder having a specified particle size distribution.

### SUMMARY OF THE INVENTION

Briefly stated, and in accordance with one aspect of the present invention, there is provided a composition comprising a melt-mixed blend of about 55 to about 95 weight percent polyacetal having a number average molecular weight of greater than 100,000 and about 5 to about 45 weight percent ultrahigh molecular weight polyethylene, wherein the weight percentages are based on the total amount of polyacetal and ultrahigh molecular weight polyethylene.

Pursuant to another aspect of the present invention, there is provided a composition as described above and further comprising one or more of lubricants, processing aids, thermal stabilizers, oxidative stabilizers, ultraviolet light stabilizers, colorants, nucleating agents, compatibilizing agents, and fillers.

Pursuant to another aspect of the present invention, there is provided an article made from the composition comprising a melt-mixed blend of about 55 to about 95 weight percent polyacetal having a number average molecular weight of greater than 100,000 and about 5 to about 45 weight percent ultrahigh molecular weight polyethylene, wherein the weight percentages are based on the total amount of polyacetal and ultrahigh molecular weight polyethylene.

Pursuant to another aspect of the present invention, there is provided an article extruded from the composition comprising a melt-mixed blend of about 55 to about 95 weight percent polyacetal having a number average molecular weight of greater than 100,000 and about 5 to about 45 weight percent ultrahigh molecular weight polyethylene, wherein the weight percentages are based on the total amount of polyacetal and ultrahigh molecular weight polyethylene.

### DETAILED DESCRIPTION OF THE INVENTION

It has been unexpectedly discovered that the melt-mixed blends of high molecular weight polyacetal and UHMWPE of the present invention have significantly improved wear resistance relative to polyacetal or UHMWPE alone. These compositions have good impact resistance and are melt processable, while possessing sufficiently low melt flow rates to allow them to be formed into profile shapes by melt extrusion.

The high molecular weight polyacetal used in the compositions of the present invention can be one or more homopolymers, copolymers, or a mixture thereof. Homopolymers are prepared by polymerizing formaldehyde and/or formaldehyde equivalents, such as cyclic oligomers of formaldehyde. Copolymers are derived from one or more comonomers generally used in preparing polyacetals in addition to formaldehyde and/formaldehyde equivalents. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyacetal copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy. The polyacetal will preferably be linear (unbranched) or have minimal chain-branching.

The high molecular weight polyacetal has a number average molecular weight of greater than 100,000, or preferably at least about 103,000, or more preferably of at least about 108,000. The number average molecular weight will still more preferably be in the range of greater than 100,000 to about 300,000. Number average molecular weight is determined by gel permeation chromatography using a light scattering detector. The high molecular weight polyacetal used in the compositions of the present invention will preferably have a melt flow rate of about 0.5 g/10 min or less or more preferably about 0.4 g/10 min or less, or yet more preferably about 0.3 g/10 min or less, as measured at 190° C. under a 2.16 kg load, following ISO method 1133.

The high molecular weight polyacetal may be prepared using any conventional method. It will be apparent to those skilled in the art that it will be necessary to ensure that the monomers and solvents used in the preparation of the polyacetal be of sufficient purity to minimize the likelihood of chain-transfer reactions that would prevent the desired high molecular weights from being obtained during the polymerization. This will often require that the concentration of chain-transfer agents such as water and/or alcohols be kept to a minimum. See, for example, K. J. Persak and L. M. Blair, “Acetal Resins,” Kirk-Othmer Encyclopedia of Chemical Technology, 3^{rd} Edition, Vol. 1, Wiley, New York, 1978, pp. 112-123.

The ultrahigh molecular weight polyethylene (UHMWPE) used in the present invention is polyethylene with a number average molecular weight that is at least about 3×10⁶. Ultra high molecular weight polyethylenes are defined by ASTM D 4020-01 a to be those linear polymers of ethylene that have a relative viscosity of 1.44 or greater, as measured at 0.02 g/ml in decalin at 135° C. The nominal viscosity molecular weight defined by the above method is at least 3.12×10⁶ g/mol.

The compositions of the present invention comprise about 5 to about 45 weight percent UHMWPE and about 55 to about 95 weight percent of high molecular weight polyacetal, or preferably about 10 to about 40 weight percent UHMWPE and about 60 to about 90 weight percent of high molecular weight polyacetal, or more preferably about 15 to about 40 weight percent UHMWPE and about 60 to about 85 weight percent of high molecular weight polyacetal, wherein the weight percentages are based on the total weight of high molecular weight polyacetal and UHMWPE.

The composition of the present invention may optionally comprise additives such as lubricants, processing aids, stabilizers (such as thermal stabilizers, oxidative stabilizers, ultraviolet light stabilizers), colorants, nucleating agents, compatibilizers, tougheners, fluoropolymer such as poly(tetrafluoroethylene), and fillers such as mineral fillers.

The compositions of the present invention are melt-mixed blends, wherein all of the polymeric components are well-dispersed within each other and the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

The compositions of the present invention may be formed into articles using methods known to those skilled in the art, such as, for example, injection molding, blow molding, extrusion, thermoforming, melt casting, and rotational molding. The composition may be overmolded onto an article made from a different material. The composition may be extruded into films. The composition may be formed into monofilaments.

Examples of suitable articles include gears; rods; sheets; strips; channels; tubes; conveyor system components such as wear strips, guard rails, rollers, and conveyor belt parts. Particularly preferred are extruded articles.

The compositions of the present invention have good physical properties and sufficiently high melt viscosity to make them useful for forming articles by melt extrusion and other melt-drawing processes and have significantly improved wear resistance over high molecular polyacetal or UHMWPE alone.

### EXAMPLES

The compositions of the Examples and Comparative Examples were prepared by melt-blending polyacetal with UHMWPE in the relative proportions indicated in Table 1 in a twin-screw extruder operated with barrel temperatures of about 190-220° C. The compositions were extruded into strands through a die having about 5/16 inch diameter holes. Following standard procedures and under ambient pressures, the strands were cooled, and cut into pellets. After exiting the die, the strands were subjected to a tensile force that reduced their diameter to about ⅛ inch as they entered first the cooling bath and then the cutter. Screw designs were selected such that the melt at the die appeared to be homogenous upon visual inspection, except for that of composition of Comparative Example 4, which appeared to be inhomogeneous and had poor melt strength. As such, it was deemed to be unsuitable for preparing samples for further testing. Slightly different screw configurations were used for the preparation of the compositions of Examples 1 and 2 and Comparative Examples 1, 2, and 4-10 from that used for the preparation of the compositions of Examples 3-5 and Comparative Example 3.

The following ingredients are used in the Examples and Comparative Examples:

UHMWPE refers to Mipelon™ XM220, supplied by Mitsui Chemicals America, Inc., Purchase, N.Y.
Polyacetal A refers to a polyacetal homopolymer having a number average molecular weight of about 108,000 and a melt flow rate of about 0.3 measured at 190° C. under a 2.16 kg load. Prior to use in the examples, the polyacetal was melt-blended with 0.025 weight percent Acrawax® C (supplied by Lonza, Inc, Fairlawn, N.J.), 0.07 weight percent Irganox® 245 and 0.03 weight percent Irganox® 1098 (supplied by Ciba Specialty Chemicals Corp, Tarrytown, N.Y.), and 0.5 weight percent polyacrylamide.
Polvacetal B refers to Delrin® 100, a polyacetal homopolymer having a number average molecular weight of about 60,000, supplied by E.I. du Pont de Nemours and Co., Wilmington, Del.
Polvacetal C refers to Delrin® 500, a polyacetal homopolymer having a number average molecular weight of about 41,000, supplied by E.I. du Pont de Nemours and Co., Wilmington, Del.
   Wear Testing Test Pieces

The compositions were injection molded into test pieces. The test pieces were disks having three flat pads protruding from one surface of the disk. The pads protruded about 0.125 in from the surface of the disk and their combined surface area was about 0.2128 in².

Melt Flow Measurement

The melt flow measurements were carried out according to ASTM D 1238095 and ISO 1133. A polymer sample, typically cylindrical pellets approximately 0.125″ in diameter and length, was predried at 80° C. under vacuum for at least 4 hours. Approximately 8 g of the pellets were fed into a heated barrel maintained at 190° C. An orifice of 0.0825″ diameter and 0.315″ length was fixed to one of the barrel. After a premelting time sufficient to form a homogeneous melt, a load of 2160 g was placed on the plunger and the extrudate through the orifice was collected at 60 s intervals. At least three of the samples taken at 60 s intervals were collected and weighed. The weights were averaged and the average values converted to yield melt index values in g/10 min. These values for the different examples and comparative examples are included in Table 1. A low melt flow rate is desirable for forming articles through a drawn melt, such as via melt extrusion or similar processes. A melt flow rate of about 0.5 g/10 min or less is preferred for use in such processes.

Notched Izod Measurement

A measurement of the fracture toughness of the different samples was obtained using the ASTM D 256-00 method for notched impact strength of thermoplastics materials. In accordance with this method, 0.5″ wide, 0.125″ thick injection molded samples were notched using a notch-cutter to yield a 45°included angle notch with a radius of curvature of 0.010″ to a depth of 0.1″. Each notched specimens was mounted in a vertical cantilevered position and impacted with an instrumented pendulum. The energy absorbed to fracture the specimens was recorded and is shown in Table 1.

Wear Testing

Wear testing was done by holding a test piece molded from the composition to be tested against a countersurface, such that the pads were in contact with the countersurface, under the action of a controlled force (or pressure), P, while rotating the test piece against the countersurface at a relative velocity, V. The countersurface was 600 grit sandpaper having abrasive particles of about 25 micrometers in median size adhered to a backing paper. A linear variable displacement transducer in the testing apparatus measured the decrease in distance between the test piece and abrasive surface (L). The test was run until at least about a third of the height of the pads had worn away, or 400 hours, whichever came first. Tests were run with (a) a pressure of 63 p.s.i. and a velocity of 48 feet per minute (fpm) and (b) a pressure of 15 p.s.i. and a velocity of 200 fpm.

The wear rate was calculated by the following formula:
wear rate=L/(P×V×t)

where: L is in inches, P is in p.s.i., V is in fpm, and t is the duration of the test in minutes. The results are shown in Table 1.

TABLE 1

| | | | | | Wear rate | | | |
|---|---|---|---|---|---|---|---|---|
| | | | | | at 63 fpm | Wear rate at | Melt flow | Notched |
| | | | | | and 48 p.s.i. | 200 fpm and 15 | rate | Izod |
| | UHMWP E | Polyacetal A | Polyacetal B | Polyacetal C | (in³/lbf · ft) | p.s.i. (in³/lbf · ft) | g/10 min | (ft.lbf/in) |
| Comp. Ex. 1 | 100 | — | — | — | 62.3 | 25.5 | <0.05 | 11 |
| Comp. Ex. 2 | — | 100 | — | — | 262 | 68 | 0.29 | 3.95 |
| Example 1 | 10 | 90 | — | — | 4.6 | 11 | 0.19 | 1.25 |
| Example 2 | 20 | 80 | — | — | 0.3 | 0.8 | 0.12 | 1.25 |
| Comp. Ex. 3 | — | 100 | — | — | 14.3 | 30.5 | 0.29 | 3.95 |
| Example 3 | 20 | 80 | — | — | 0.1 | 0.6 | 0.12 | 1.25 |
| Example 4 | 30 | 70 | — | — | 0.1 | 0.4 | <0.1 | 0.90 |
| Example 5 | 40 | 60 | — | — | 0.07 | 0.13 | <0.1 | 0.76 |
| Comp. Ex. 4 | 50 | 50 | — | — | n/m | n/m | n/m | n/m |
| Comp. Ex. 5 | — | — | 100 | — | 6.3 | 12.6 | 1.74 | 2.02 |
| Comp. Ex. 6 | 10 | — | 90 | — | 0.8 | 6.7 | 0.98 | 0.83 |
| Comp. Ex. 7 | 20 | — | 80 | — | 0.23 | 1.2 | 0.48 | 0.7 |
| Comp. Ex. 8 | — | — | — | 100 | 6.7 | 57 | 9.8 | 1.31 |
| Comp. Ex. 9 | 10 | — | — | 90 | 1.3 | 27 | 5.2 | 0.7 |
| Comp. Ex. 10 | 20 | — | — | 80 | 0.2 | 0.5 | 2.2 | 0.69 |

Ingredient quantities are given in weight percent based on the total weight of the composition.
“n/m” means “not measured”

A comparison of Comparative Examples 1 and 2 with Examples 1 and 2 and a comparison of Comparative Example 1 and 3 with Examples 3-5 demonstrates that an unexpected and significant synergistic effect on wear resistant is obtained for blends of high molecular weight polyacetal containing UHMWPE relative to the wear resistance of high molecular weight polyacetal or UHMWPE alone, where the blends of the Examples have excellent wear resistance.

In the case of the preparation of Comparative Example 4, when the sample was subjected to a tensile force upon exiting the extruder die, the extrudate fractured, meaning that such a composition would be unsuitable for use in melt-processes that exert a tensile force on the molten material such as melt extrusion. In the case of Examples 1-5, the sample exiting the extruder die had good melt strength and could be easily cut into pellets. These materials are suitable for use in melt-processes that exert a tensile force on the molten material such as melt extrusion.

It is therefore, apparent that there has been provided in accordance with the present invention, a composition and article(s) that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A composition comprising a melt-mixed blend of about 55 to about 95 weight percent polyacetal having a number average molecular weight of greater than 100,000 and about 5 to about 45 weight percent ultrahigh molecular weight polyethylene, wherein the weight percentages are based on the total amount of polyacetal and ultrahigh molecular weight polyethylene.

2. The composition of claim 1, wherein the polyacetal has a number average molecular weight of at least about 103,000.

3. The composition of claim 1, wherein the polyacetal has a number average molecular weight of at least about 108,000.

4. The composition of claim 1, wherein the polyacetal is present in about 60 to about 90 weight percent and the ultrahigh molecular weight polyethylene is present in about 10 to about 40 weight percent, wherein the weight percentages are based on the total amount of polyacetal and ultrahigh molecular weight polyethylene.

5. The composition of claim 1, wherein the polyacetal is present in about 60 to about 85 weight percent and the ultrahigh molecular weight polyethylene is present in about 15 to about 40 weight percent, wherein the weight percentages are based on the total amount of polyacetal and ultrahigh molecular weight polyethylene.

6. The composition of 1, wherein the polyacetal has a melt flow rate of less than or equal to about 0.5 g/10 min, wherein said melt flow rate is determined using ISO Method 1133 measured at 190° C. under a 2.16 kg load.

7. The composition of 1, wherein the polyacetal has a melt flow rate of less than or equal to about 0.4 g/10 min, wherein said melt flow rate is determined using ISO Method 1133 measured at 190° C. under a 2.16 kg load.

8. The composition of 1, wherein the polyacetal has a melt flow rate of less than or equal to about 0.3 g/10 min, wherein said melt flow rate is determined using ISO Method 1133 measured at 190° C. under a 2.16 kg load.

9. The composition of claim 1, wherein the polyacetal is a homopolymer.

10. The composition of claim 1, wherein the polyacetal is unbranched.

11. The composition of claim 1, further comprising one or more of lubricants, processing aids, thermal stabilizers, oxidative stabilizers, ultraviolet light stabilizers, colorants, nucleating agents, compatibilizing agents, and fillers.

12. An article made from the composition of claim 1.

13. The article of claim 12, made by injection molding, blow molding, extrusion, thermoforming, melt-casting, or rotational molding.

14. The article of claim 13, made by injection molding.

15. The article of claim 14 in the form of a gear.

16. An article extruded from the composition of claim 1.

17. The article of claim 16 in the form of a rod, sheet, strip, or tube.

18. The article of claim 16 in the form of a conveyer system wear strip, guard rail, or conveyer belt component.

19. The article of claim 12 in the form of a roller.
